(19) United States
(12) Patent Application Publication
(10) Pub. No.: US 2011/0249927 A1
(43) Pub. Date: Oct. 13, 2011

(54) RADIAL BEARINGS OF INCREASED LOAD CAPACITY AND STABILITY WITH ONE AXIALLY ASYMMETRIC BEARING COMPONENT

(76) Inventor: Slobodan Tepic, Zurich (CH)

(21) Appl. No.: 12/839,407

(22) Filed: Jul. 20, 2010

Related U.S. Application Data
(60) Provisional application No. 61/226,761, filed on Jul. 20, 2009.

(51) Int. Cl. F16C 33/66

(52) U.S. Cl. 384/517

(57) ABSTRACT

The invention increases load capacity and stability of radial bearings by modifying the geometry of the bearing in the transverse cross section so as to split the conventional, single contact zone into two contact zones, each preferably offset by about 45 degrees from the load axis. Depending on the application, one or the other of the paired bearing components is axially asymmetric. The needed shape can be pre-machined into a bearing component, produced by permanent deformation of an axially symmetric component, or induced by assembly into/onto housing/shaft of the rotating members. Expected gain in load bearing capacity is about 40%; dynamic stability can also be significantly improved, which is of particular interest in fluid film lubricated journal bearings.

### BACKGROUND

1. Field of the Invention

The invention relates to radial bearings of increased load capacity and stability attained by modifying the geometry of the bearing so as to change the load-transferring contact zone from a single one, located directly under the load vector, to the one split in two principal load transferring zones, preferably at 90 degrees to each other and at 45 degrees off the main load axis.

2. Discussion of Related Art

A limited search by the inventor has not uncovered any highly relevant prior art in the field of radial bearings. Conceptually the closest prior art, cited later in the disclosure, relates to the joint prosthesis. Most of the recent patents in the field, aiming at improved performance of the bearings deal with the materials and surface treatments rather than geometry. A sample of those is cited below.

U.S. Pat. No. 7,543,385 B2, by Kaminski et al. discloses a method for manufacturing improved contact surfaces in rolling contact bearings resulting in micro-pockets that retain the lubricant.

U.S. Pat. No. 6,837,946 B2, by Beswick et al. discloses a method of production, wherein the suitable steels are subjected to plastic deformation prior to hardening, resulting in improved fatigue performance of the bearing.

U.S. Pat. No. 6,371,656 B1, by De Vries et al. discloses a surface topography with recesses for improved contact lubrication.

U.S. Pat. No. 6,340,245 B1, by Horton et al. discloses a bearing with the rolling elements and at least one of the raceways with a metal-mixed diamond-like coating.

U.S. Pat. No. 5,885,690, by Sada discloses sparse but deep recesses in the contact surfaces which improve lubrication without significantly diminishing the area of contact.

U.S. Pat. No. 4,856,466, by Ting et al. discloses recesses for lubricant retention on contact surfaces of e.g. camshafts.

### SUMMARY OF THE INVENTION

According to one aspect of the invention, a radial journal bearing with a stationary outer main component comprises an axially symmetric shaft rotating within an axially asymmetric bushing providing two principal load-transferring contact zones at about 45 degrees from the main load vector, about 90 degrees to each other. The direction of the main load vector is assumed to be relatively steady in relation to the stationary bushing.

According to another aspect of the invention, a radial rolling bearing is provided with an axially asymmetric stationary outer race, which provides two load-transferring contact zones to the rolling elements (balls, rollers or needles). Again, the two principal load-transferring contact zones are located at preferably about 45 degrees to the main load vector.

According to another aspect of the invention, a stationary axially asymmetric shaft provides two load-transferring contact zones to a rotating, axially symmetric bushing.

According to yet another aspect of the invention, a stationary, inner, axially asymmetric race of a rolling bearing provides two load-transferring contact zones to the rolling elements supporting the outer, rotating axially symmetric race. An example is the rolling bearing of a rotating wheel.

In all cases, the needed geometry can be obtained either by machining or by very slight deformation of axially symmetric components conventionally produced. The deformation can be either permanent, pre-installed into a bearing component, or it can be produced by the shape of the shaft or of the housing into which the bearing is mounted. Expected load capacity gain is on the order of 40%. If the bearing diameter were retained, the frictional moment would be correspondingly increased. However, the increased load capacity could result in a smaller bearing being selected, hence decreasing the moment of friction with still a significant overall design advantage.

Another, perhaps equally important issue is the inherent stability of the bearings according to the invention. In journal bearings maintenance of the fluid film lubrication at two principal load-transferring contact zones, spaced apart by about 90 degrees, is easier and much less prone to instabilities inherent in a single contact support with a required radial clearance. In rolling bearings, many applications now calling for preloaded bearings may achieve acceptable precision with a split support according to the invention.

### BRIEF DESCRIPTION OF THE DRAWINGS

FIG. 1 is a schematic cross sectional view of: a) a conventional radial bearing with a single load-transferring contact zone between the rotating shaft and a stationary bushing, and b) a radial bearing according to the invention with two load-transferring contact zones at 45 degrees to the load axis.

FIG. 2 is a schematic cross sectional view of a conventional rolling contact radial bearing with the rotating inner race and the stationary outer race.

FIG. 3 shows a possible process of deforming the outer race of a conventionally produced rolling contact radial bearing in order to split the single contact zone in two contact zones.

FIG. 4 is a schematic cross sectional view of a rolling contact radial bearing according to the invention demonstrating the effect of the axially asymmetric outer race on the load distribution.

FIG. 5 is a cross sectional view of a stationary outer race machined to eliminate the direct, single contact zone under the load.

FIG. 6 is a cross sectional view of a stationary outer race machined in multiple steps to smooth-out the contour of the race.

FIG. 7 is a schematic cross sectional view of: a) a conventional radial bearing with a single load-transferring contact zone between a stationary shaft and the rotating bushing, and b) a radial bearing according to the invention with two load-transferring contact zones at 45 degrees to the load axis.

FIG. 8 is a schematic cross sectional view of a rolling contact radial bearing according to the invention demonstrating the effect of a stationary, axially asymmetric inner race on the load distribution to the rotating outer race.

FIG. 9 is a schematic cross sectional view of an axially asymmetric housing for a stationary outer race of a rolling contact radial bearing, machined so as to deform the outer race upon assembly by press-fitting.

FIG. 10 is a schematic cross sectional view of an axially asymmetric shaft for a stationary inner race of a rolling contact radial bearing, machined so as to deform the inner race upon assembly by press-fitting.

### DETAILED DISCLOSURE

For a simple and clear presentation, two examples of radial bearings have been chosen for this disclosure, one of a journal bearing and one of a rolling contact ball-bearing, but the same technical arguments and design approaches can be used for most radial bearings. The present invention is an extension of a prior invention by the inventor as set forth in PCT Patent Application No. WO2008/058756, published on May 22, 2008, which is incorporated herein, in its entirety, by reference (“the Tepic Application”). The Tepic Application discloses an artificial joint prosthesis, such as a hip prosthesis, in which the convex and concave components have differences in shape to provide a broad contact surface. As set forth in the Tepic Application, the differences in shape between the components further provide improved lubrication of the components.

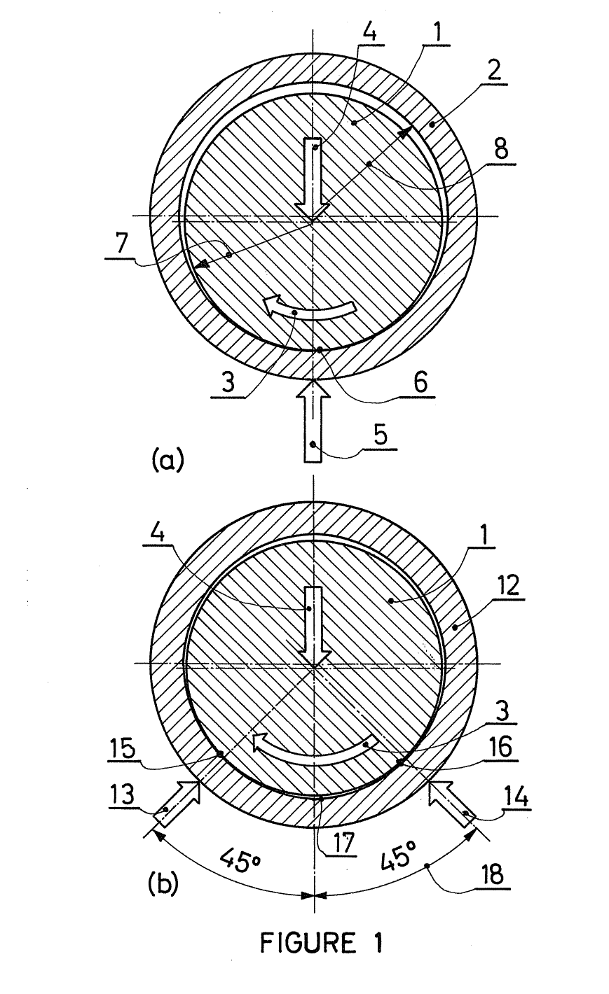

FIG. 1a shows a conventional radial journal bearing with an axially symmetric shaft 1 rotating, as shown by arrow 3, within a stationary bushing 2. The shaft load, shown by arrow 4, is transferred over a contact zone 6 to the bearing bushing, causing bearing reaction 5. The radius 7 of the shaft 1, is smaller than the radius 8 of the bushing by a radial clearance in order to guarantee free rotation. In highly loaded, high demand bearings such as those found in turbines and generators, a lubricant fluid film is formed under steady dynamic conditions keeping solid surfaces fully separated. In many other applications radial journal bearings are running dry on suitably paired materials, one usually being much softer and exhibiting low coefficient of friction.

FIG. 1b shows a journal bearing with a modified geometry of the bushing 12, in such a way that the rotating shaft 1 cannot contact the bushing directly under the load 4, but instead does so at two contact zones 15 and 16, where the load reactions are 13 and 14. If the offset angle 18 is equal to 45 degrees, as shown here, the magnitude of each of the reactions 13 and 14 is equal to about 0.707 of the magnitude of the load 4 and this is the minimum possible. A gap 17 is created between the shaft 1 and the bushing 12 directly under the load 4. Design of the bushing 12 can provide the same radius of curvature at the contact zones 15 and 16 as that present at the contact zone 6 in FIG. 1a, i.e. there need not be any change in Herzian stress distributions between the two cases. However, with this arrangement it is also possible to provide a closer fit, hence reduced Herzian stresses, as disclosed in the Tepic Application.

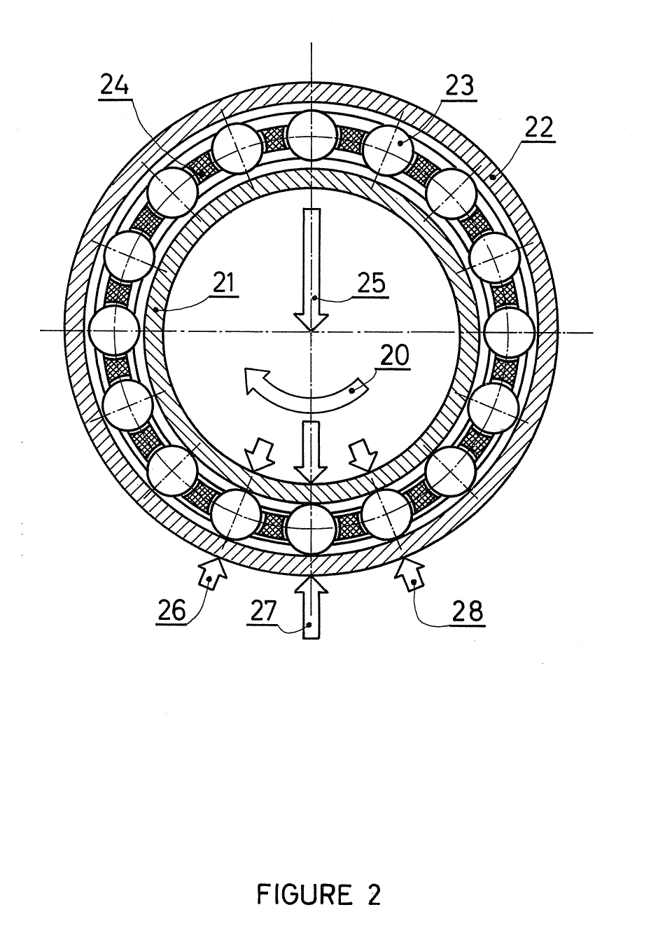

FIG. 2 illustrates load distribution in a conventional radial ball bearing. The inner race 21 and the outer race 22 are both axially symmetric, with deep grooves provided for balls 23 to run within as the inner race rotates as shown by arrow 20. The balls are kept apart by a cage 24. A radial clearance, shown exaggerated, limits the concurrent contact of both races to only a few of the balls 23; in this case to the 3 directly below the load 25, producing reactions 26, 27 and 28. The average normal radial clearance for this kind of a bearing is about 1/1000 of the inner diameter (standardized by e.g. ISO 5753:1991, or DIN 620); it goes to zero for pre-loaded precision bearings.

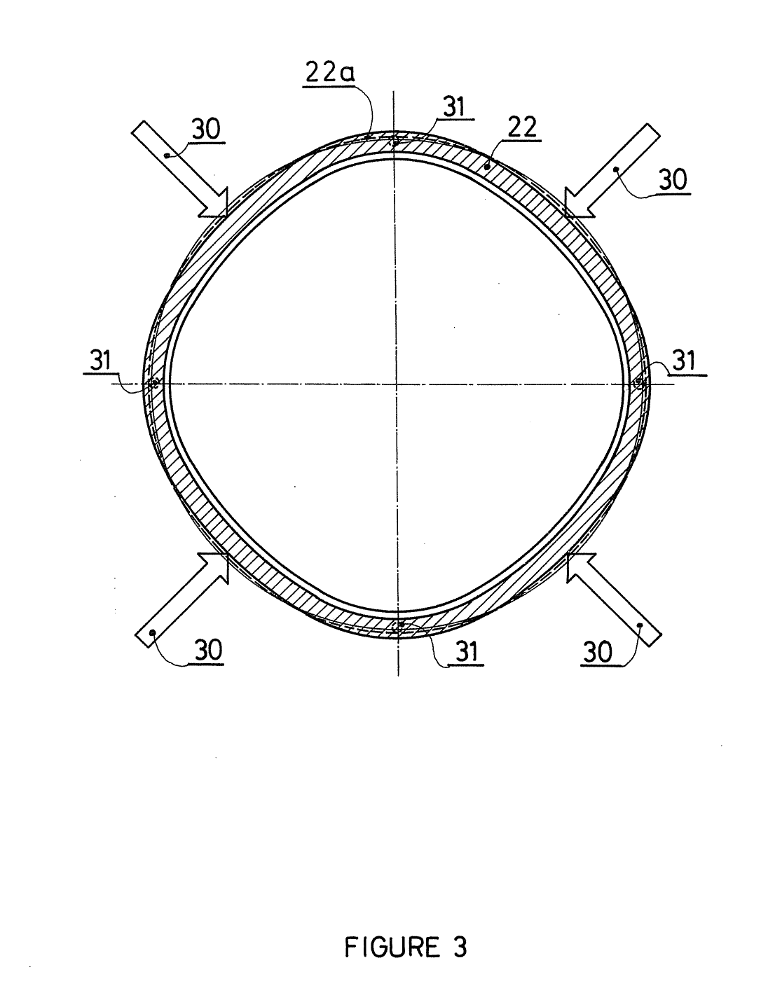

FIG. 3 shows how a conventional, axially symmetric outer race 22 could be deformed with four forces 30 with a residual deformation leaving the race in the shape 22a. For a proper orientation in assembly, the race should be marked, as shown by markers 31, showing the position(s) to where the load should be oriented.

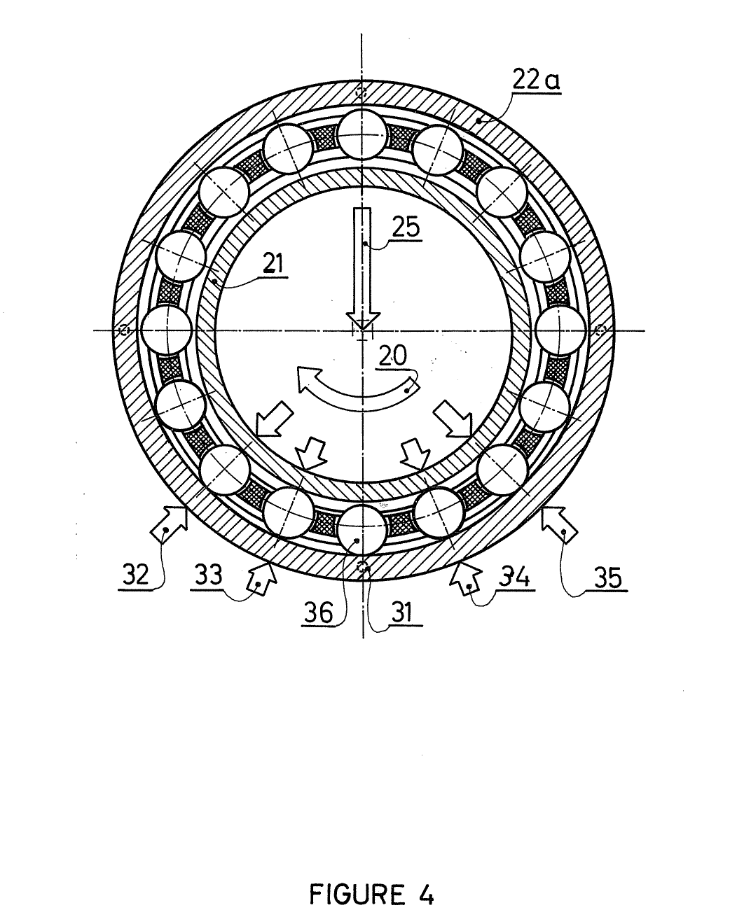

FIG. 4 illustrates load distribution with an axially asymmetric outer race 22a, as the inner race 21 rotates as indicated by arrow 20. The ball 36 directly under the load 25, above the marker 31, is not loaded. Instead, four other balls generate reactions 32, 33, 34 and 35, which together balance the load 25.

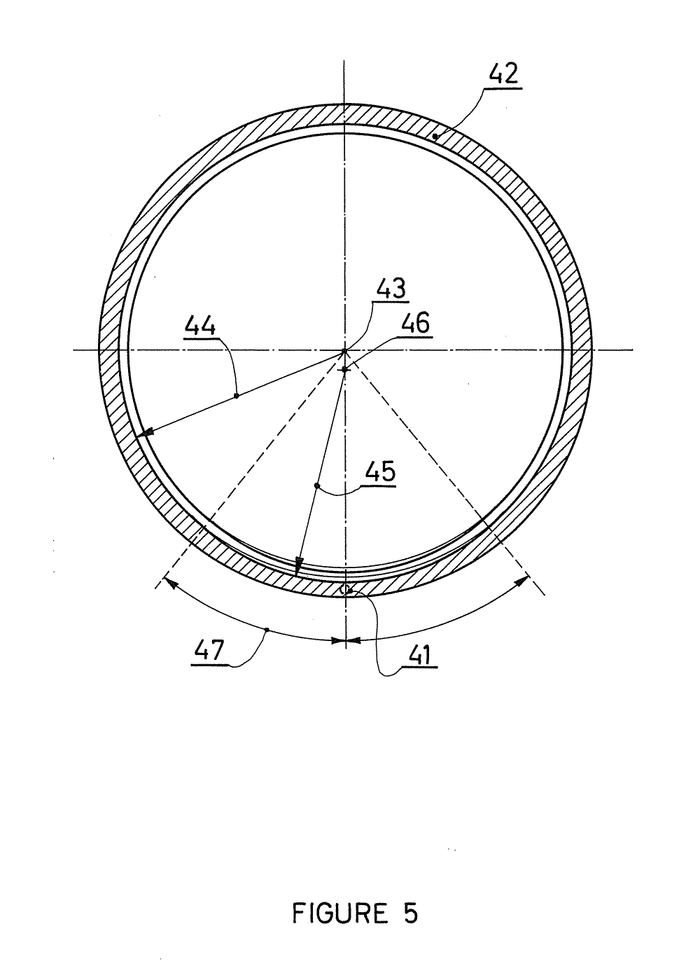

FIG. 5 shows how a conventional, axially symmetric outer race 42 can be modified by machining the ball groove deeper over the marker 41. The nominal radius 44 of the groove centered at 43, is changed to a smaller radius 45 with the center at 46, modifying the contour of the groove over the half-angle 47.

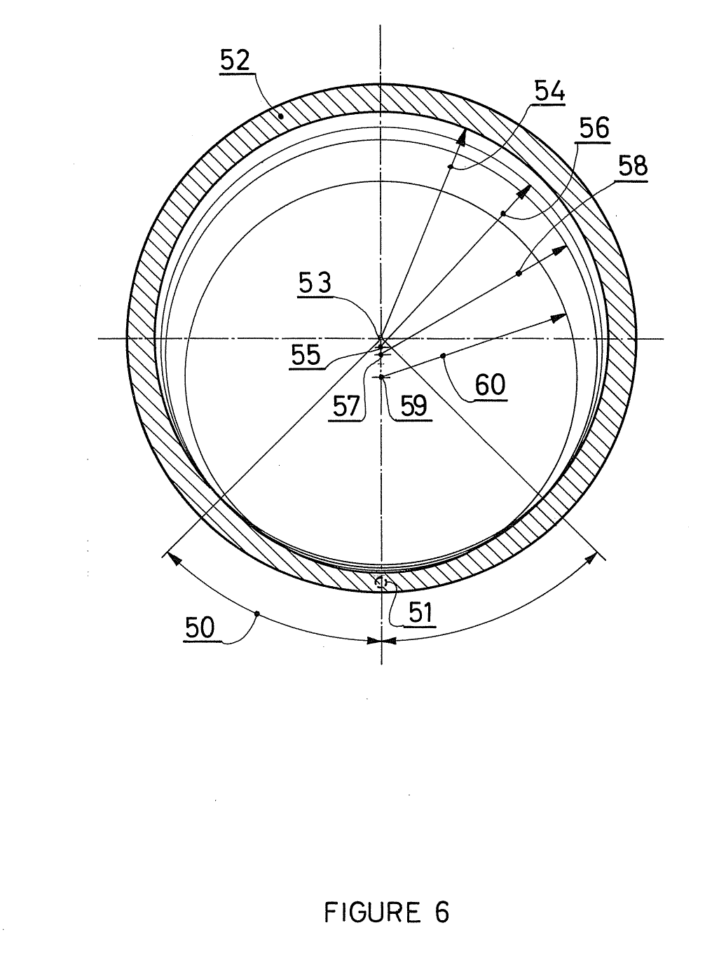

FIG. 6 shows another variation of the inner groove shape modifications of the outer race 52, using several radii from the nominal 54, centered at 53, through 56, 58 and 60 centered at 55, 57 and 59, respectively. The deviation from axial symmetry is made over the half-angle 50 and is centered at the marker 51. In extreme, a continuous variation in the radius of curvature and the location of the center of curvature can be executed by CNC turning/grinding.

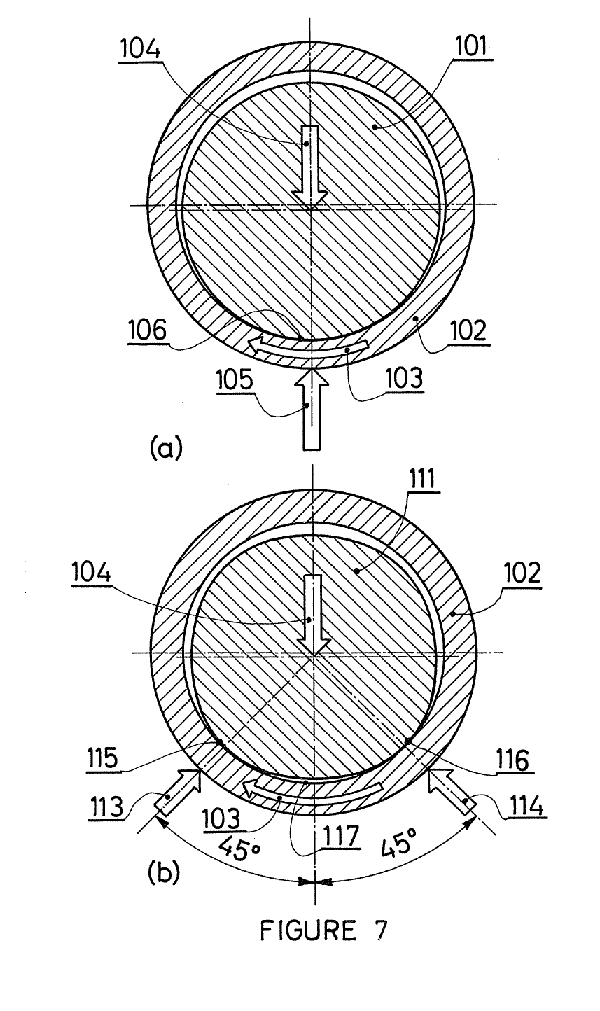

FIG. 7 a) shows a stationary shaft 101 with a rotating bushing 102 of a conventional radial journal bearing. Rotation is indicated by arrow 103; the load by arrow 104; the reaction by arrow 105. A single load-transferring zone 106, defined by the Herzian and/or dynamic fluid film stress distribution is located directly between the load 104 and the reaction 105.

FIG. 7 b) shows a modified bearing according to the invention, wherein the stationary shaft 111 is axially asymmetric allowing for two load-transferring contact zones 115 and 116 offset from the load 104 direction by an angle of preferably 45 degrees. The reaction of the bushing 102, rotating as shown by arrow 103, is now split in two components 113 and 114. A gap 117 separates the two contact zones 115 and 116.

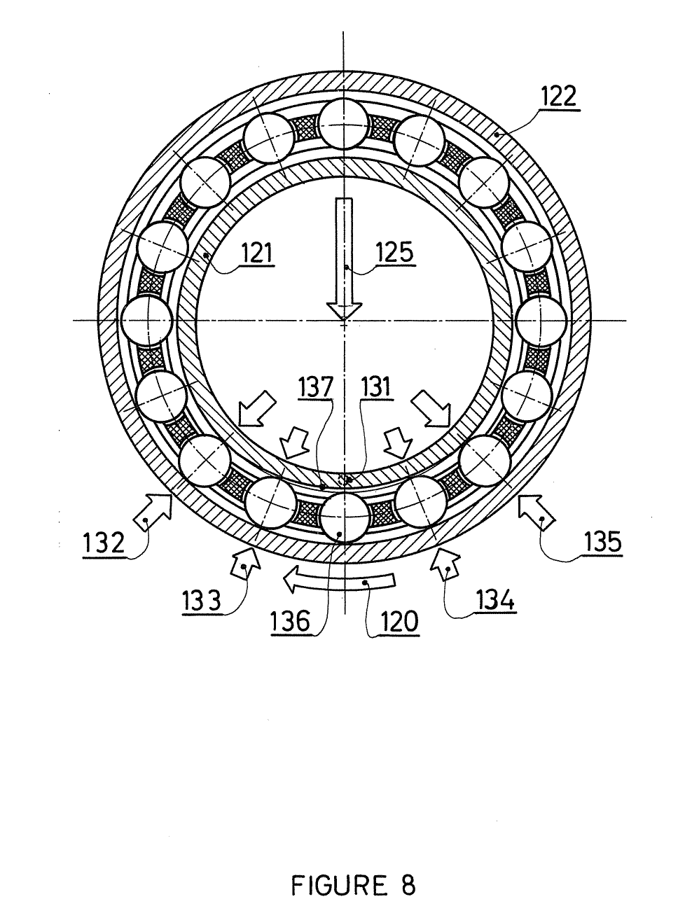

FIG. 8 shows a rolling contact ball bearing according to the invention, wherein the inner stationary race 121 is axially asymmetric with a deviation creating a gap 137 at location marked by a marker 131, so that the ball 136 directly under the load 125 is unloaded. Instead, the load 125 generates offset reactions 132, 133, 134 and 135 to the rotating—as indicated by arrow 120—axially symmetric outer race 122. The largest of the reactions is about 0.7 times the largest reaction in a conventional bearing shown on FIG. 2.

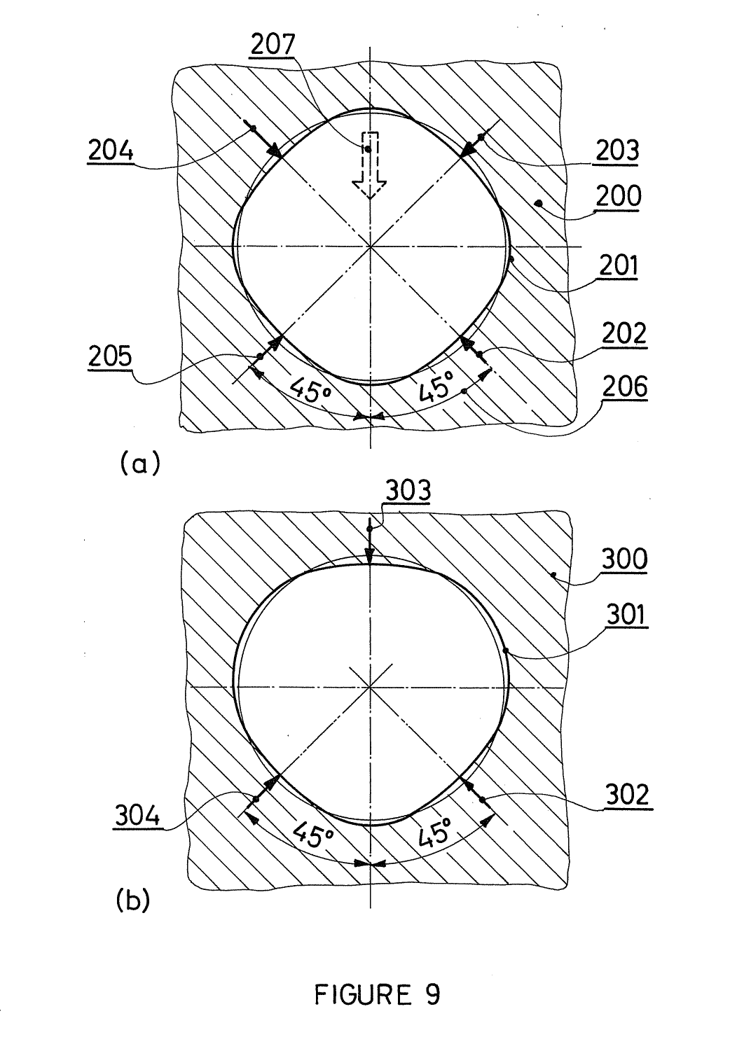

FIG. 9 a) shows an axially asymmetric housing 200 according to the invention for a stationary outer race or a bushing of a conventional radial bearing, wherein the inner contour 201 is shaped so as to result in compression along the arrows 202, 203, 204 and 205, offset by the half angle 206 of preferably 45 degrees from the anticipated load direction 207 on the rotating shaft.

FIG. 9 b) shows an alternative housing shape 300, with three roundness deviations of the contour 301, shown by arrows 302, 303 and 304. In all cases the amount of deviation is subject to calculation and testing so as to result in the desired shape alteration of the press-fitted bearing race or bushing.

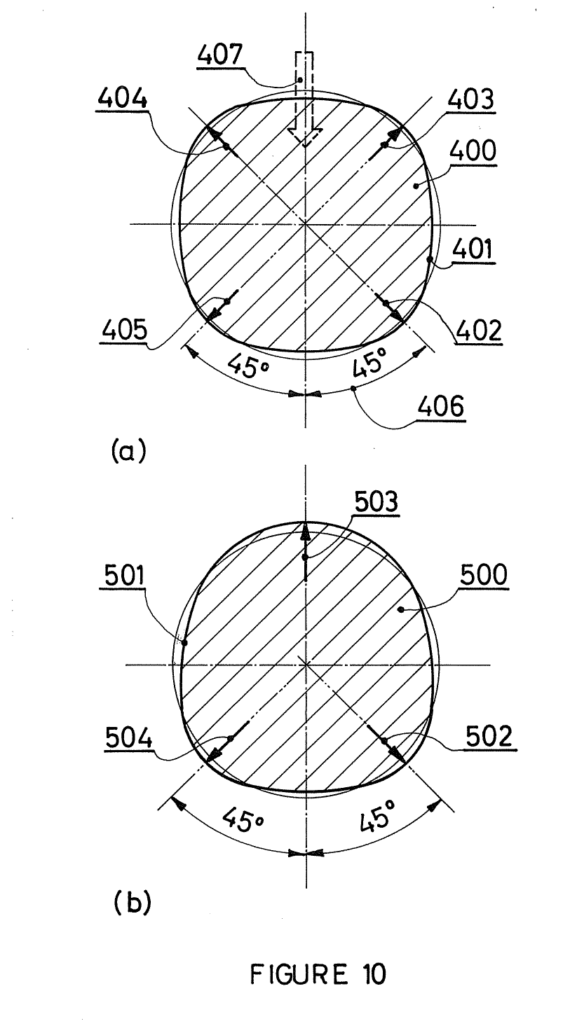

FIG. 10 a) shows an axially asymmetric stationary shaft 400, with its contour 401 deviating from roundness as indicated by arrows 402, 403, 404 and 405 to distort the inner race of the press fitted bearing so that the contact zones to the rotating outer race are offset by the angle of preferably 45 degrees to the anticipated load direction 407.

FIG. 10 b) shows an alternative three-point shape deviation—shown by arrows 502, 503 and 504—of the stationary shaft's 500 contour 501 that results in the offset contact zones, by preferably 45 degrees, to the rotating outer race of the bearing.

It will be clear to those skilled in art that minor modifications of the disclosed examples can lead to particular solutions which can have further advantages. For example, the 45 degrees theoretically best placement for a pair of reactions can in certain applications be compromised for a 35 degree placement, as is sometimes done in for example split-ring radial-axial bearings in the longitudinal direction. Technically feasible ranges, from the approximate analysis, and depending on the general tolerances of the bearing, are 50 to 100 degrees for the angle between the principal load-transferring contact zones, i.e. 25 to 50 degrees for each of the zones relative to the load direction. Also, the principal load-transferring zones do not need to be fully separated, as shown in the disclosure for clearer presentation, but may well overlap resulting in an even more uniform stress distribution.

1. A radial bearing with one of the two main bearing components axially symmetric and the other axially asymmetric resulting in two principal load-transferring contact zones.

2. A radial bearing according to claim 1 wherein the two principal load-transferring zones are at preferably 50 to 100 degrees to each other and are offset from the main load direction by preferably 25 to 50 degrees each.

3. A radial bearing according to claim 1 wherein the two principal load-transferring zones are at preferably 90 degrees to each other and are offset from the main load direction by preferably 45 degrees each.

4. A radial bearing according to claim 1 wherein the two principal load-transferring zones are at preferably 70 degrees to each other and are offset from the main load direction by preferably 35 degrees each.

5. A radial bearing according to claim 1 wherein the two principal load-transferring zones are partially overlapping.

6. A radial bearing according to claim 1 wherein the axially asymmetric main component is the stationary bushing of a journal bearing.

7. A radial bearing according to claim 1 wherein the axially asymmetric main component is the stationary outer race of a rolling contact bearing.

8. A radial bearing according to claim 1 wherein the axially asymmetric main component is the stationary shaft of a journal bearing.

9. A radial bearing according to claim 1 wherein the axially asymmetric main component is the stationary inner race of a rolling contact bearing.

10. A radial bearing according to claim 1 wherein the axially asymmetric main component is manufactured in its final shape by machining.

11. A radial bearing according to claim 1 wherein the axially asymmetric main component is manufactured in its final shape by deformation of an axially symmetric component.

12. A radial bearing according to claim 1 wherein the axially asymmetric shape of the main component is generated by deformation in the process of assembly.
